(19) United States
(12) Patent Application Publication
(10) Pub. No.: US 2002/0068024 A1
(43) Pub. Date: Jun. 6, 2002

(54) Gas scrubber system

(75) Inventors: Jeong Ho Park, Kyonggi-do (KR); Seon Uk Jang, Kyonggi-do (KR); Sung Hoon Kim, Seoul (KR)

Correspondence Address: LOWE HAUPTMAN GOPSTEIN, GILMAN AND BERNER LLP, SUITE 310, 1700 DIAGONAL ROAD, ALEXANDRIA, VA, 22314

(73) Assignee: Taeyang Tech Co., Ltd.

(21) Appl. No.: 09/949,731

(22) Filed: Sep. 12, 2001

(30) Foreign Application Priority Data
Dec. 4, 2000 (KR) 2000-72840
May 11, 2001 (KR) 2001-25830

(51) Int. Cl. F01N 3/10; B01D 50/00; F01N 3/00

(52) U.S. Cl. 422/173; 422/168; 422/170; 422/169; 422/198

(57) ABSTRACT

A gas scrubber system for purifying waste gas into clean air has first and second waste gas combustors for oxidizing waste gas introduced thereinto by heat and hot filtering particulates present in the oxidized waste gas, a gas channel switching unit for controlling flow of the waste gas introduced into the first and the second waste gas combustors, first and second coolers disposed downstream of the first and the second waste gas combustors for cooling down the oxidized waste gas discharged from the first and the second waste gas combustors, and a cold filtering unit disposed downstream of the first and the second coolers for filtering particulates present in the cold waste gas discharged from the first and the second coolers.

### BACKGROUND OF THE INVENTION

1. Field of the Invention

The present invention relates to a gas scrubber system for purifying waste gas, which is discharged from a chemical process, into clean air.

2. Description of the Related Art

Waste gas emitted from a usual chemical process and a semiconductor manufacturing process is highly detrimental to the human body because it has a tendency to exhibit strong toxicity, explosiveness and corrosiveness. Moreover, severe environmental pollution may be caused in the event that the waste gas is discharged into the atmosphere with no treatment. For this reason, it is necessary to have the waste gas discharged into the atmosphere only after it is subjected to a reliable purifying process, whereby detrimental ingredients contained in the waste gas can be reduced to a concentration no greater than an allowable limit.

Various gas scrubber systems are utilized in purifying the waste gas, each of which employs one or more of a combustion mode, a wet mode, an adsorption mode, a cooling mode and a catalyst mode. Especially, in consideration of safety, economy and efficiency, it is usual for the conventional gas scrubber systems to employ the combustion mode, the wet mode and the adsorption mode in combination.

In a gas scrubber system simultaneously employing the combustion mode, the wet mode and the adsorption mode, the waste gas is directly oxidized by a heater element of a combustion unit, and then water is sprayed to the oxidized gas while the latter passes through a wet chamber, so as to eliminate particulates from the oxidized gas.

However, in the conventional three mode gas scrubber system as noted just above, a large quantity of water is required to eliminate particulates, which leads to the production of an increased amount of wastewater. Since the wastewater has to be purified by a separate equipment, the gas scrubber system are costly to operate and maintaim.

Another problem lies in that the three mode gas scrubber system requires frequent repair and maintenance, since the particulates tend to adhere to ducts or drain lines through which the oxidized gas passes, and in certain circumstances, cause filter elements to be clogged, thereby disturbing the flow of the oxidized gas. Especially, the particulates generated in the process of waste gas combustion are easily adhered to the inner wall of ducts with the aid of moisture entrained in the oxidized gas. This may result in unwanted corrosion of the ducts or other like parts and shorten the life span of the gas scrubber system.

Meanwhile, in a two mode gas scrubber system employing the combustion mode and the cooling mode, waste gas is directly oxidized by the heat generated from a heater element of a combustion unit, and the oxidized gas is cooled by a cooling unit, and then particulates are eliminated by means of a dust-collecting apparatus. However, when a dust collection is carried out at the end of oxidized gas cooling process, the particulates are adhered to gas-draining conduits, thereby disturbing the flow of the oxidized gas. If the particulates in the oxidized gas are of strong acid property, they would rust the gas-draining conduits and may eventually generate an accident of gas-leakage.

Moreover, in order to have the conventional gas scrubber systems stopped for repair and maintenance, it would be unavoidable to temporally shut down the entire chemical process or otherwise the waste gas has to be directly exhausted into the atmosphere at the expense of environmental pollution.

### SUMMARY OF THE INVENTION

Accordingly, it is an object of the present invention to provide a gas scrubber system whereby the particulates present in the thermally oxidized waste gas can be eliminated in advance of a cooling process, thereby preventing gas exhaust tubes from being clogged or corroded by the gas-laiden particulates.

Another object of the present invention is to provide a gas scrubber system that shows greatly improved combustion efficiency, cooling efficiency, and dust-collecting efficiency over the prior art scrubber system.

A further object of the present invention is to provide a gas scrubber system capable of continuously treating the waste gas with no stoppage of waste gas flow even when the system is under repair and maintenance.

A still further object of the present invention is to provide a gas scrubber system that requires no use of water and therefore can avoid any production of wastewater or corrosive moisture.

In accordance with one aspect of the invention, there is provided a gas scrubber system comprising: first and second waste gas combustors for oxidizing waste gas by heat and firstly filtering particulates in the oxidized waste gas; a gas channel switching unit for controlling flow of the waste gas introduced into the first and the second waste gas combustors; first and second coolers disposed downstream of the first and the second waste gas combustors, so as to cool the oxidized waste gas discharged from the first and the second waste gas combustors; and a cold filtering unit disposed downstream of the first and the second coolers, so as to secondly filter particulates in the oxidized waste gas discharged from the first and the second coolers, wherein each of the first and the second waste gas combustors comprises: a combustor housing having a waste gas introduction port, a combustion chamber, and a waste gas discharge port; a hollow cylindrical burner having a combustion channel interconnecting the waste gas introducing port and the combustion chamber with each other, the burner being disposed downward at a center of the combustor housing and applying heat to the waste gas passing through the combustion channel; a hot filtering unit disposed between the combustion chamber and the waste gas discharge port of the combustor housing, so as to filter particulates in burned waste gas; and a dust-collecting unit disposed under the combustion chamber of the combustor housing, so as to collect the particulates falling from the combustion chamber.

### BRIEF DESCRIPTION OF THE DRAWINGS

The above objects, and other features and advantages of the present invention will become more apparent after a reading of the following detailed description when taken in conjunction with the drawings, in which:

FIG. 1 is a view schematically showing the entire construction of a gas scrubber system according to the present invention;

FIG. 2 is a perspective view showing the construction of first and second waste gas combustors employed in the gas scrubber system shown in FIG. 1;

FIG. 3 is a partially cutout perspective view of the first or the second waste gas combustor, showing a combustor housing, a burner, a hot filtering unit, and first and second dust-collecting units thereof;

FIG. 4 is a front sectional view of the first or the second waste gas combustor shown in FIG. 3;

FIG. 5 is a side sectional view of the first or the second waste gas combustor shown in FIG. 3;

FIG. 6 is an enlarged sectional view of a burner employed in the first and the second waste gas combustors, showing the construction of the burner;

FIG. 7 is an enlarged sectional view of a part of a hot filtering unit employed in the first and the second waste gas combustors, showing the construction of the hot filtering unit; and

FIG. 8 is an enlarged sectional view of a first cooler or a second cooler according to the present invention.

### DETAILED DESCRIPTION OF PREFERRED EMBODIMENTS

The above and other objects, characteristics, and advantages of the present invention will be apparent from the following description along with the accompanying drawings.

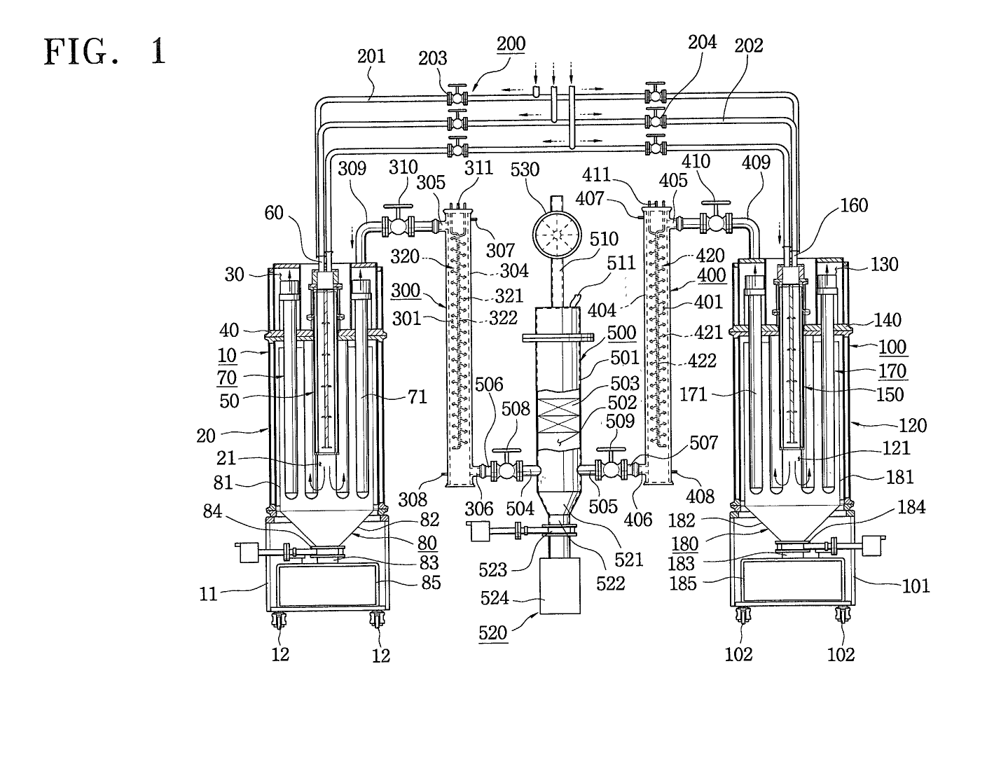

Referring first to FIG. 1, a gas scrubber system according to the present invention includes first and second waste gas combustors 10 and 100 respectively for burning waste gas, which contains particulates of SiH₄, NH₃, PH₃, and H₂ generated in such processes as a usual chemical process and a semiconductor manufacturing process, so as to generate oxidized gas. The first and the second waste gas combustors 10 and 100 have the same construction and are operated in the same way with each other. It should be appreciated that the present invention is not limited to the gas scrubber system incorporating the first and the second waste gas combustors 10 and 100 but includes a gas scrubber system that employs a single gas combustor.

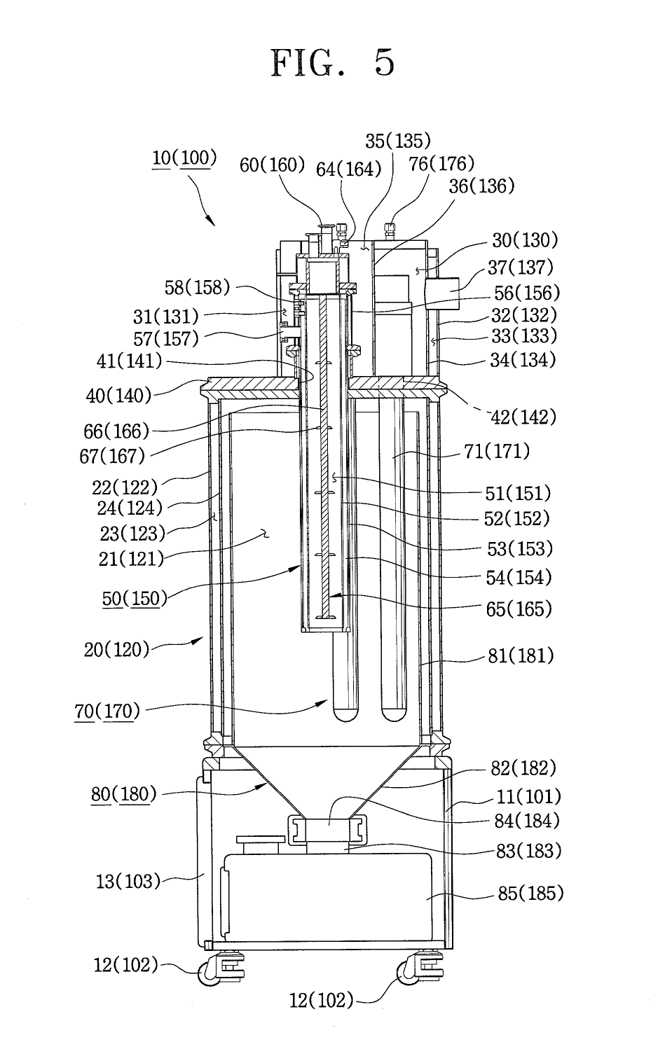

As best illustrated in FIGS. 1 and 5, frames 11 and 101 of the first and the second waste gas combustors 10 and 100 are supported by wheels 12 and 102, and doors 13 and 103 are provided at front faces of the frames 11 and 101. Further, combustor housings 20 and 120 are respectively mounted on the frames 11 and 101 of the first and the second waste gas combustors 10 and 100, and combustion chambers 21 and 121 in the combustor housings 20 and 120 are respectively surrounded by outer cases 22 and 122, and inner cases 24 and 124, which are disposed inside of the outer cases 22 and 122 with intervals corresponding to cooling channels 23 and 123. In order to achieve a heat-insulating effect, cooling water is supplied into the cooling channels 23 and 123 between the outer cases 22 and 122 and the inner cases 24 and 124. Instead, according to necessity, solid adiabatic material may be interposed between the outer cases 22 and 122 and the inner cases 24 and 124.

Moreover, discharge chambers 30 and 130 for discharging the burned waste gas, namely the oxidized gas, out of the first and the second waste gas combustors 10 and 100, are arranged above the combustion chambers 21 and 121. The discharge chambers 30 and 130 are respectively surrounded by outer cases 32 and 132 having open spaces 31 and 131 arranged at the front of the outer cases 32 and 132, inner cases 34 and 134 disposed inside of and spaced from the outer cases 32 and 132 to form cooling channels 33 and 133 between the inner cases 34 and 134 and the outer cases 32 and 132, and center cases 36 and 136 having installing spaces 35 and 135, which are formed in the center cases 36 and 136 and communicate with the open spaces 31 and 131. The discharge chambers 30 and 130 of the first and the second waste gas combustors 10 and 100 are connected to waste gas discharge ports 37 and 137, and mounting plates 40 and 140 are disposed between the combustion chambers 21 and 121 and the discharge chambers 30 and 130. Central holes 41 and 141 are formed at centers of the mounting plates 40 and 140, and pluralities of through holes 42 and 142 are formed around the central holes 41 and 141 so as to interconnect the combustion chambers 21 and 121 and the discharge chambers 30 and 130 with each other.

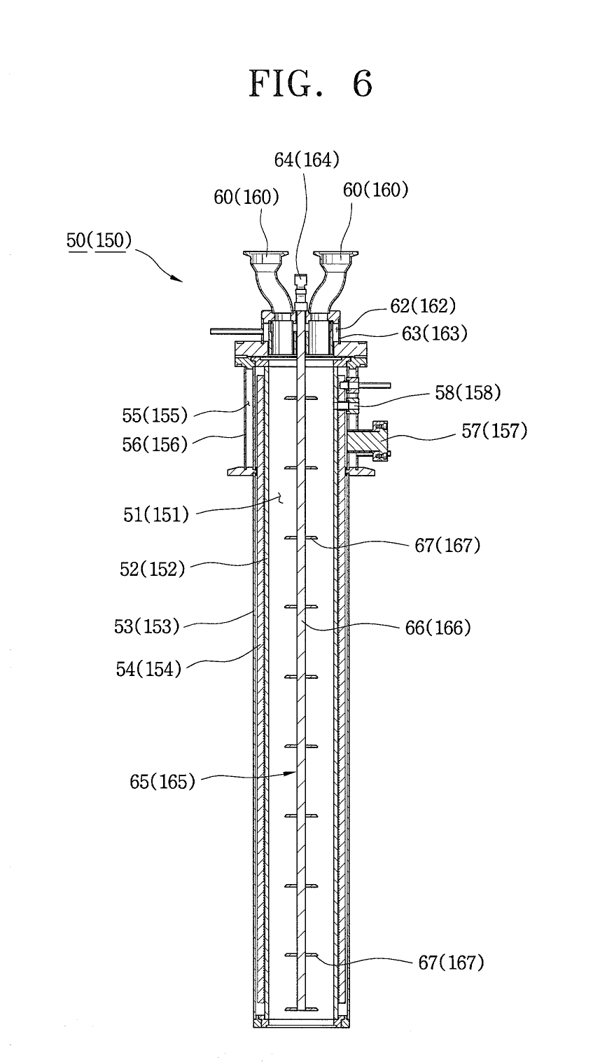

Referring to FIGS. 1, 3, and 6, burners 50 and 150 respectively having a hollow cylindrical shape and for burning waste gas are disposed in the combustion chambers 21 and 121 of the first and the second waste gas combustors 10 and 100. The burners 50 and 150 include inner combustion tubes 52 and 152 vertically extending through the central holes 41 and 141 of the mounting plates 40 and 140 at centers of the combustion chambers 21 and 121 and having combustion channels 51 and 151 interconnected to the combustion chambers 21 and 121, outer combustion tubes 53 and 153 disposed outside of and spaced from the inner combustion tubes 52 and 152, and heater elements 54 and 154 disposed between the inner combustion tubes 52 and 152 and the outer combustion tubes 53 and 153. Upper sides of the burners 50 and 150 are exposed to the installing spaces 35 and 135 of the discharge chambers 30 and 130, and outer cases 56 and 156 are disposed around portions of outer surfaces of the burners 50 and 150 exposed to the installing spaces 35 and 135 of the discharge chambers 30 and 130, so as to form cooling channels 55 and 155. At the portions of the outer surfaces of the burners 50 and 150 are disposed temperature sensors 58 and 158 for sensing temperature and electric connectors 57 and 157 for supplying electric power necessary to operate the heater elements 54 and 154.

Further, waste gas introduction ports 60 and 160 communicating with the combustion channels 51 and 151 are connected to the upper sides of the burners 50 and 150, so as to supply waste gas to the burners 50 and 150. Inner cases 61 and 161 are disposed outside of the waste gas introduction ports 60 and 160 connected to the upper sides of the burners 50 and 150, and outer cases 63 and 163 are disposed outside of the inner cases 61 and 161 so as to form cooling channels 62 and 162 outside of the inner cases 61 and 161. To the upper sides of the burners 50 and 150 are connected air supply tubes 64 and 164 for supplying air, which is necessary to burn the waste gas, to the combustion channels 51 and 151. At the centers of the burners 50 and 150 are disposed auxiliary rod heaters 65 and 165 for inducing the waste gas to flow along the inner surfaces of the burners 50 and 150 while applying heat to the waste gas, thereby facilitating combustion of the waste gas. The auxiliary rod heaters 65 and 165 include thin elongated center rods 66 and 166 extending along the centers of the combustion channels 51 and 151, and a plurality of baffle discs 67 and 167 disposed at the center rods 66 and 166 with intervals along the longitudinal directions of the center rods 66 and 166.

With reference to FIGS. 1, 3, 5, and 7, hot filtering units 70 and 170 for eliminating particulates entrained in the oxidized gas introduced from the combustion chambers 21 and 121 into the discharge chambers 30 and 130 by adsorption are disposed through the through holes 42 and 142 of the mounting plates 40 and 140. The hot filtering units 70 and 170 include pluralities of column-type ceramic filters 71 and 171, which extend vertically in parallel with the burners 50 and 150.

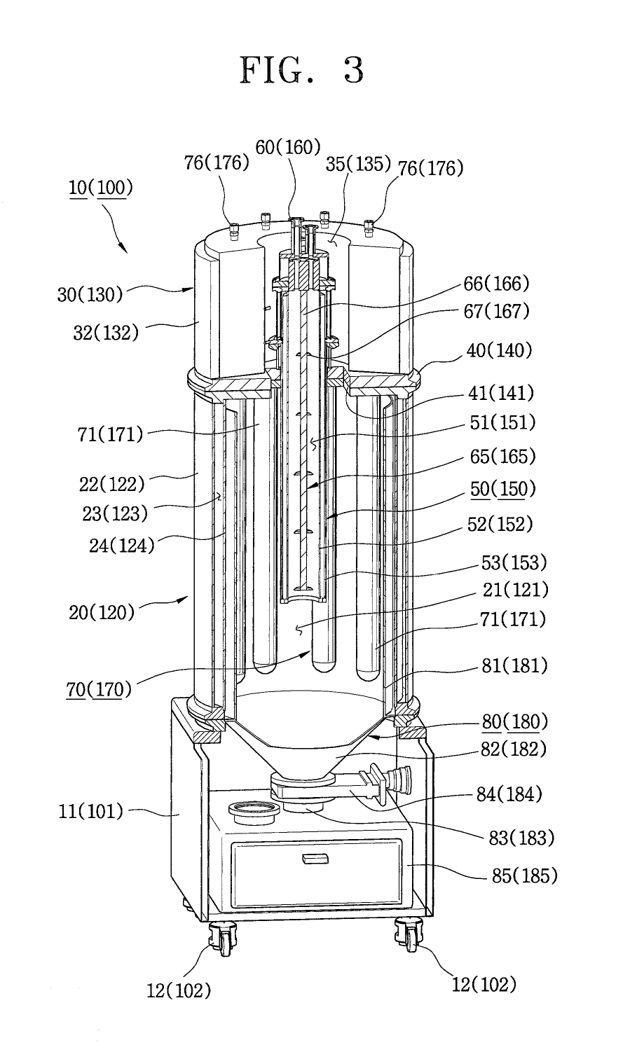

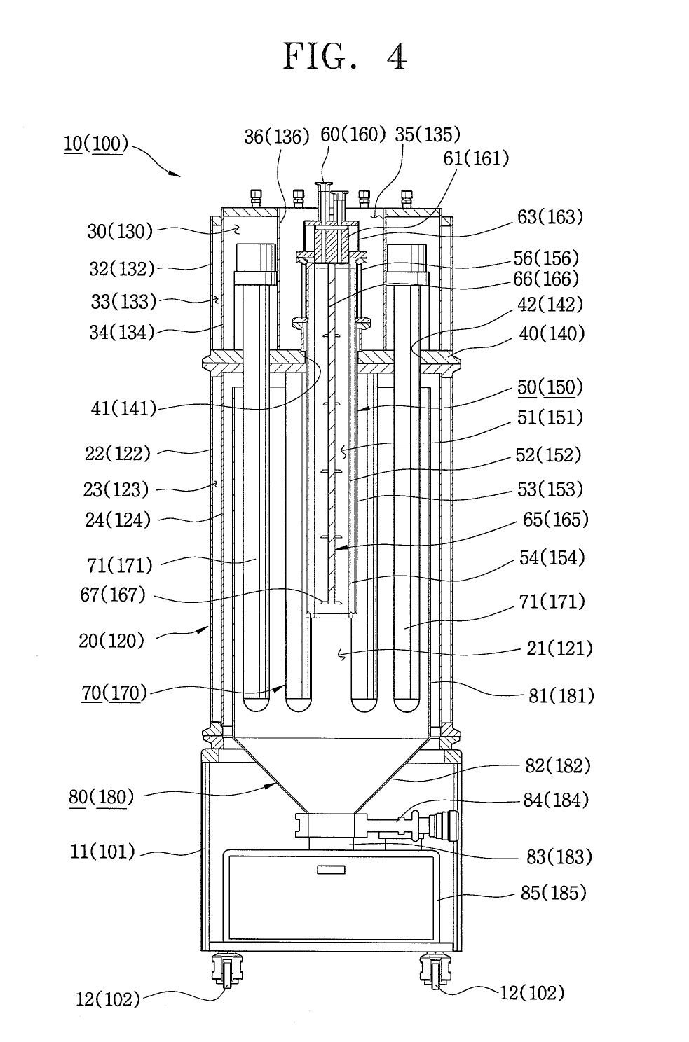

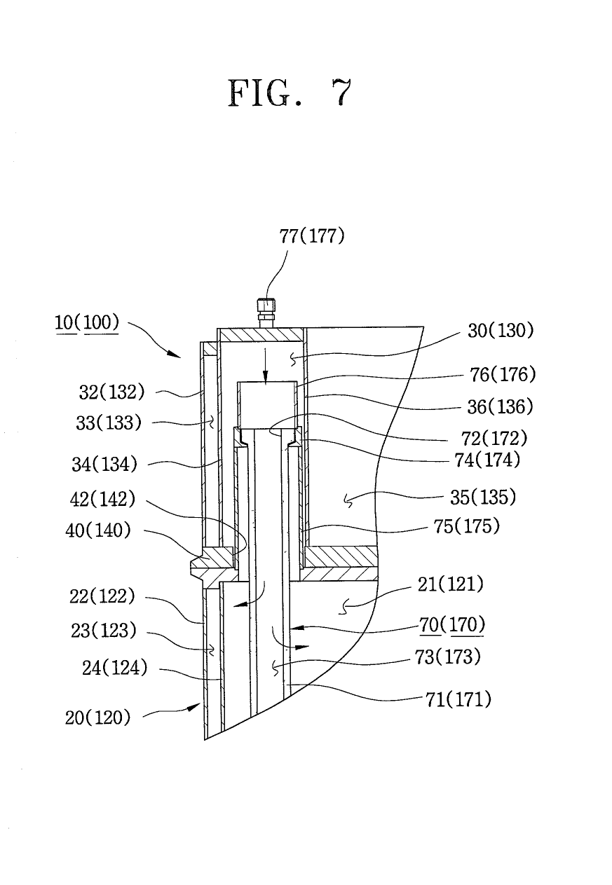

As shown in FIGS. 5 and 7, the ceramic filters 71 and 171 extend through the through holes 42 and 142 of the mounting plates 40 and 140 in such a manner as that their lower ends are located lower than the burners 50 and 150 and their upper ends are disposed in the discharge chambers 30 and 130. Moreover, at centers of the ceramic filters 71 and 171 are formed discharge channels 73 and 173, whose lower ends are closed and upper ends are discharge ports 72 and 172. The upper ends of the ceramic filters 71 and 171 disposed in the discharge chambers 30 and 130 are fixed by holders 74 and 174, which are fitly surrounded by sleeves 75 and 175 fixedly supporting the holders 74 and 174. The holders 74 and 174 and the sleeves 75 and 175 prevent the oxidized gas, which passes through the discharge channels 73 and 173 of the ceramic filters 71 and 171, from being discharged through other portions than the discharge ports 72 and 172. On the ceramic filters 71 and 171 are disposed guide tubes 76 and 176 for inducing the oxidized gas to be discharged through the discharge ports 72 and 172. As shown in FIGS. 3 to 5, pluralities of pulse jet nozzles 77 and 177, which function as filter cleaners for periodically flowing air backward, namely spraying air, to the discharge channels 73 and 173 of the ceramic filters 71 and 171, so as to forcedly detach alien material fixedly adhered to the ceramic filters 71 and 171, are disposed on the discharge chambers 30 and 130 in such a manner as to be aligned with the discharge channels 73 and 173 of the ceramic filters 71 and 171.

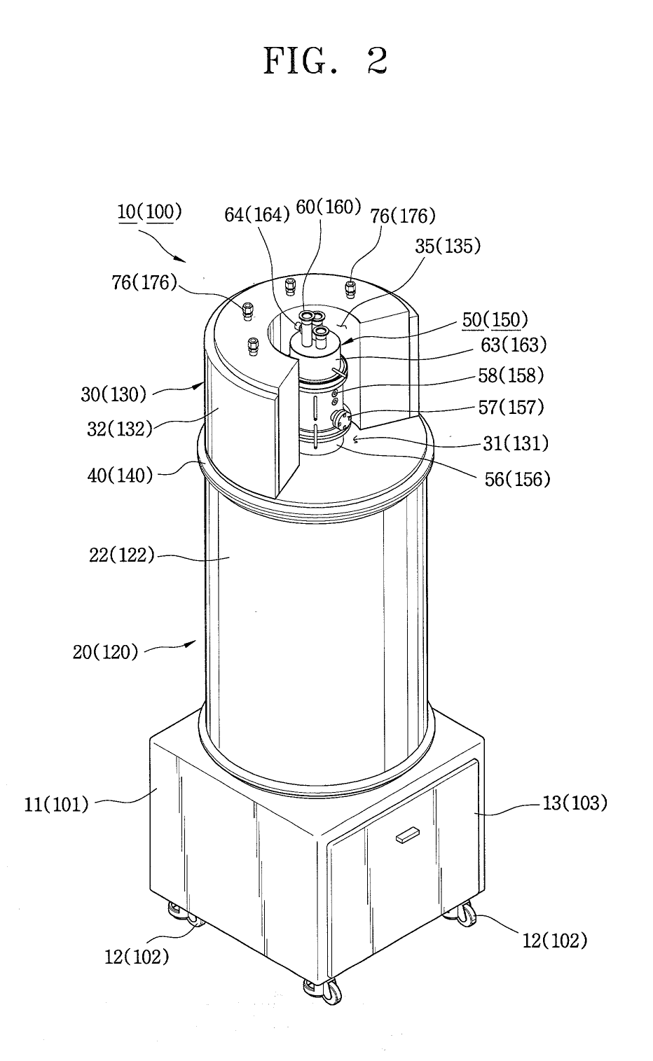

Referring again to FIGS. 1 to 5, the gas scrubber system of the present invention further includes first and second dust-collecting units 80 and 180 respectively disposed under the combustion chambers 21 and 121 to collect falling particulates. The first and the second dust-collecting units 80 and 180 include cylindrical dust-collecting tubes 81 and 181 disposed inside of the combustion chambers 21 and 121 and near the inner cases 24 and 124, hoppers 82 and 182 connected to lower ends of the dust-collecting tubes 81 and 181 and having gradually decreasing sectional areas so as to facilitate discharge of the particulates, gate valves 84 and 184 disposed in such a manner as to open and close discharge ports 83 and 183 of the hoppers 82 and 182, and collector boxes 85 and 185 for collecting the particulates discharged through the gate valves 84 and 184. The collector boxes 85 and 185 can be drawn out of the first and the second waste gas combustors 10 and 100 after the doors 13 and 103 of the frames 11 and 101 are opened, in a state that the discharge ports 83 and 183 of the hoppers 82 and 182 are closed by the gate valves 84 and 184.

As apparent from FIG. 1, the scrubber system of the present invention further includes a gas channel switching unit 200 for controlling the flow of the waste gas introduced into the first and the second waste gas combustors 10 and 100. The gas channel switching unit 200 includes a plurality of first waste gas supply tubes 201 and a plurality of second waste gas supply tubes 202 respectively connected to the waste gas introduction ports 60 and 160 of the first and the second waste gas combustors 10 and 100, and first and the second valve mechanisms 203 and 204 respectively provided at the first and the second waste gas supply tubes 201 and 202 to intercept the flow of the waste gas. Although there are shown in the drawings three first waste gas supply tubes 201 and three second waste gas supply tubes 202 connected to the waste gas introduction ports 60 and 160 of the first and the second waste gas combustors 10 and 100, the number of the first and the second waste gas supply tubes 201 and 202 may be properly selected.

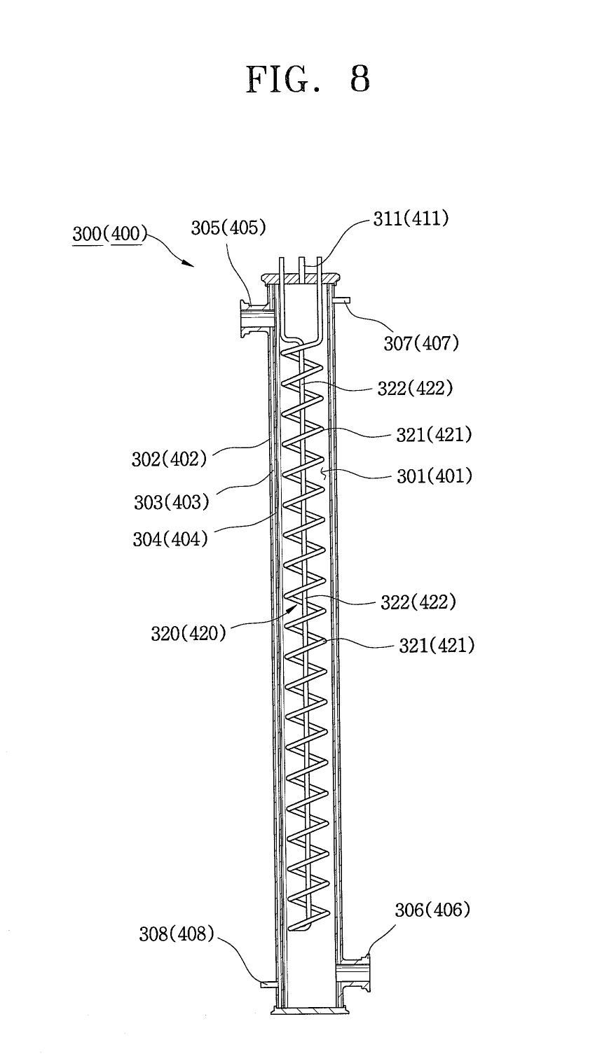

Referring to FIGS. 1 and 8, the scrubber system of the present invention further includes first and second coolers 300 and 400 respectively connected to the discharge chambers 30 and 130 of the first and the second waste gas combustors 10 and 100 to cool the oxidized gas. Since the first and the second coolers 300 and 400 have the same construction, the constructions and operations of the first and the second coolers 300 and 400 will be simultaneously described hereinbelow. First and second cooling chambers 301 and 401 of the first and the second coolers 300 and 400 include cylindrical outer cases 302 and 402, and inner cases 304 and 404 disposed inside of the outer cases 302 and 402 so as to form cooling channels 303 and 403 between the outer cases 302 and 402 and the inner cases 304 and 404. The opposite ends of the first and the second coolers 300 and 400 are connected to oxidized gas introduction ports 305 and 405 and oxidized gas discharge ports 306 and 406 communicating with the first and the second cooling chambers 301 and 401, and cooling water introduction ports 307 and 407 and cooling water discharge ports 308 and 408 communicating with the cooling channels 303 and 403. The oxidized gas introduction ports 305 and 405 of the first and the second coolers 300 and 400 communicate with the oxidized gas discharge ports 306 and 406 of the cooling water discharge ports 308 and 408 through connection tubes 309 and 409, at which are provided third and fourth valve mechanisms 310 and 410 for controlling the flow of the oxidized gas, together with pipe accessories.

Further, nitrogen gas supply tubes 311 and 411 for supplying nitrogen gas into the first and the second cooling chambers 301 and 401 in the flowing direction of the oxidized gas are respectively connected to one side of each of the first and the second coolers 300 and 400. In the first and the second coolers 300 and 400 are disposed cooling tubes 320 and 420, which enable cooling water to flow along the first and the second cooling chambers 301 and 401 of the first and the second coolers 300 and 400, so as to facilitate cooling of the oxidized gas. The cooling tubes 320 and 420 include spiral tube sections 321 and 421 wound in a spiral shape along the longitudinal directions of the cooling tubes 320 and 420, and straight tube sections 322 and 422 connected to lower ends of the spiral tube sections 321 and 421. Ends of the straight tube sections 322 and 422 and ends of the spiral tube sections 321 and 421 are exposed to the exterior of the first and the second cooling chambers 301 and 401.

Referring again to FIG. 1, the gas scrubber system of the present invention further includes a cold filtering unit 500 connected to the first and the second coolers 300 and 400, so as to finally filter the cooled oxidized gas. The cold filtering unit 500 includes at least one filter element 503 disposed in a filtering chamber 502 of a cylindrical filter case 501 extending vertically, so as to eliminate the particulates from the oxidized gas by adsorption. Oxidized gas introduction ports 504 and 505 of the filter case 501 communicate with the oxidized gas discharge ports 306 and 406 of the first and the second coolers 300 and 400 through connection tubes 506 and 507, at which are provided fifth and sixth valve mechanisms 508 and 509 for controlling the flow of the oxidized gas, together with pipe accessories. An exhaust tube 510 for exhausting clean air purified through the filter element 503 is connected to an upper end of the filter case 501, and a pulse jet nozzle 511 functioning as a filter cleaner, which periodically sprays air into the filtering chamber 502 to forcedly detach alien material fixedly adhered to the filter element 503, is provided at the upper end of the filter case 501.

Further, at a lower end of the filter case 501 is provided a third dust-collecting unit 520 for collecting the particulates filtered by the filter element 503. The third dust-collecting unit 520 is connected to the lower end of the filter case 501. The third dust-collecting unit 520 includes a hopper 521 connected to the lower end of the filter case 501 and having a gradually decreasing sectional areas so as to facilitate discharge of the particulates, a gate valve 523 disposed in such a manner as to open and close a discharge port 522 of the hopper 521, and a collector box 524 for collecting the particulates discharged through the gate valve 523. Moreover, the exhaust tube 510 of the cold filtering unit 500 is connected to a blower 530 for forcedly exhausting the clean air out of the filtering chamber 502.

Hereinafter, described will be an operation of the gas scrubber according to the present invention, having the construction as described above.

First, referring to FIG. 1, the flow of waste gas generated in processes such as a chemical process and a semiconductor manufacturing process is controlled the first and the second valve mechanisms 203 and 204 provided at the first and the second waste gas supply tubes 201 and 202. In other words, when both of the first and the second valve mechanisms 203 and 204 of the gas channel switching unit 200 are open, the waste gas is processed after being introduced through the waste gas introduction ports 60 and 160 of the first and the second waste gas combustors 10 and 100 into the combustion channels 51 and 151 of the burners 50 and 150. Therefore, the quantity of processed waste gas can be increased by simultaneously using both of the first and the second waste gas combustors 10 and 100.

Meanwhile, only one of the first and the second waste gas combustors 10 and 100 may be operated with the other kept shut down. For example, when the first valve mechanism 203 is opened while the second valve mechanism 204 is closed so as to prevent the waste gas from being supplied through the second waste gas supply tubes 202, the waste gas can be processed through a continuous operation of the first waste gas combustor 10 and simultaneously the second waste gas combustor 100 can be subjected to repair and maintenance. On the contrary, when the first waste gas combustor 10 is to be repaired, the second valve mechanism 204 is opened while the first valve mechanism 203 is closed to prevent the waste gas from being supplied through the first waste gas supply tubes 201. When the first and the second waste gas combustors 10 and 100 are independently operated by means of the gas channel switching unit 200 as described above, processes such as the chemical process can be continuously treated without interrupting the flow of the waste gas.

Referring to FIGS. 1, 4, and 6, when the waste gas has been introduced through the waste gas introduction ports 60 and 160 of the first and the second waste gas combustors 10 and 100 into the combustion channels 51 and 151 of the burners 50 and 150, the waste gas is heated to be oxidized gas by the heater elements 54 and 154 and the center rod heaters 65 and 165. In this case, the waste gas flows downward along the combustion channels 51 and 151 of the burners 50 and 150 to collide with the baffle discs 67 and 167 of the center rod heaters 65 and 165, thereby diffusing radially outward, which results in an increased combustion efficiency of the waste gas. Moreover, particulates generated by the combustion of the waste gas fall from the combustion channels 51 and 151 of the burners 50 and 150, to be collected through the hoppers 82 and 182 and the gate valves 84 and 184 of the dust-collecting tubes 81 and 181 into the collector boxes 85 and 185.

Further, the oxidized gas discharged into the combustion chambers 21 and 121 from the combustion channels 51 and 151 of the burners 50 and 150 is heated again at circumferences of the burners 50 and 150 while generating upward airflow. Therefore, an incomplete combustion of the waste gas is prevented. The oxidized gas is discharged from the combustion chambers 21 and 121 through the discharge channels 73 and 173 of the ceramic filters 71 and 171 into the discharge chambers 30 and 130, and the ceramic filters 71 and 171 eliminate the particulates entrained in the oxidized gas by adsorption. That is, the particulates in the oxidized gas cannot escape out of the combustion chambers 21 and 121 but remain intact in the combustion chambers 21 and 121 due to the ceramic filters 71 and 171 or adsorbed by the ceramic filters 71 and 171. Furthermore, the particulates remaining intact in the combustion chambers 21 and 121 fall and are collected in the collector boxes 85 and 185.

As shown in FIG. 7, the pulse jet nozzles 77 and 177 of the first and the second waste gas combustors 10 and 100 periodically spray compressed air, and the airflow sprayed from the pulse jet nozzles 77 and 177 is guided through the discharge ports 72 and 172 of the ceramic filters 71 and 171 into the discharge channels 73 and 173 by the guide tubes 76 and 176. This airflow by the pulse jet nozzles 77 and 177 forcedly detach alien material fixedly adhered to the ceramic filters 71 and 171, and the detached alien material falls and is collected in the collector boxes 85 and 185. Therefore, the ceramic filters 71 and 171 are prevented from being blocked by the alien material, so that not only the filtering function can be continuously performed, but also the dust-collecting efficiency can be improved.

Referring to FIGS. 1 and 8, the oxidized gas in the discharge chambers 30 and 130 is introduced through the waste gas discharge ports 37 and 137, the connection tubes 309 and 409, and the oxidized gas introduction ports 305 and 405 of the first and the second coolers 300 and 400 into the first and the second cooling chambers 301 and 401. Then, the oxidized gas introduced in the first and the second cooling chambers 301 and 401 forms downward airflow toward the oxidized gas discharge ports 306 and 406 from the oxidized gas introduction ports 305 and 405. The oxidized gas flowing in the first and the second cooling chambers 301 and 401 of the first and the second coolers 300 and 400 is cooled by cooling water flowing from the cooling water introduction ports 307 and 407 through the cooling channels 303 and 403 to the cooling water discharge ports 308 and 408. Moreover, the oxidized gas flowing in the first and the second cooling chambers 301 and 401 of the first and the second coolers 300 and 400 is cooled by the cooling water flowing through the cooling tubes 320 and 420, so as to largely increase the cooling efficiency for the oxidized gas. Furthermore, nitrogen gas of cryogenic temperature is supplied through the nitrogen gas supply tubes 311 and 411 into the first and the second cooling chambers 301 and 401 of the first and the second coolers 300 and 400, to maximize the cooling efficiency for the oxidized gas.

The oxidized gas cooled by the first and the second coolers 300 and 400 is introduced through the oxidized gas discharge ports 306 and 406 of the first and the second coolers 300 and 400, the connection tubes 506 and 507, and the oxidized gas introduction ports 504 and 505 of the cold filtering unit 500 into the filtering chamber 502. The oxidized gas introduced in the filtering chamber 502 passes through the filter element 503 by means of the operation of the blower 530. The filter element 503 finally eliminates by adsorption the particulates generated due to the cooling of the oxidized gas. The clean air purified by the filter element 503 is exhausted into the atmosphere through the exhaust tube 510.

Further, the particulates filtered by the filter element 503 of the cold filtering unit 500 fall through the discharge port 522 of the hopper 521 and the gate valve 523 to be collected in the collector box 524. The pulse jet nozzle 511 of the cold filtering unit 500 periodically sprays compressed air to detach alien material fixedly adhered to the filter element 503, in the same manner as the pulse jet nozzles 77 and 177 of the first and the second waste gas combustors 10 and 100, and the detached alien material falls and is collected in the collector box 524.

As described above, according to the gas scrubber system of the present invention, the particulates entrained in the oxidized gas can be eliminated while they are hot and in advance of oxidized gas cooling process. This will prevent the gas exhaust tubes from being clogged or corroded by the particulates. Further, in the gas scrubber system of the invention, the first and the second waste gas combustors and the first and the second coolers are used in combination with each other, so that the waste gas can be continuously processed without stopping the flow of the waste gas even when the system is under repair and maintenance. Moreover, the first and the second coolers have improved constructions, so as to enable the gas scrubber system to show largely improved combustion efficiency, cooling efficiency, and dust-collecting efficiency for the waste gas. Furthermore, the gas scrubber system can efficiently purify the waste gas by means of the hot filtering units and the cold filtering unit, even without having to use any water.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

What is claimed is:

1. A gas scrubber system comprising:
first and second waste gas combustors for oxidizing waste gas by heat and for filtering particulates present in the oxidized waste gas while the gas is hot;
a gas channel switching unit for controlling flow of the waste gas introduced into the first and the second waste gas combustors;
first and second coolers disposed downstream of the first and the second waste gas combustors for cooling down the oxidized waste gas discharged from the first and the second waste gas combustors; and
a cold filtering unit disposed downstream of the first and the second coolers for filtering particulates present in the cold waste gas discharged from the first and the second coolers,
wherein each of the first and the second waste gas combustors comprises:
a combustor housing having a waste gas introduction port, a combustion chamber and a waste gas discharge port;
a hollow cylindrical burner having a combustion channel interconnecting the waste gas introduction port and the combustion chamber with each other, the burner extending downwards at a center of the combustor housing and adapted to apply heat to the waste gas passing through the combustion channel;
a hot filtering unit disposed between the combustion chamber and the waste gas discharge port of the combustor housing for filtering particulates present in the burned waste gas; and
a dust-collecting unit disposed beneath the combustion chamber of the combustor housing for collectig the particulates falling from the combustion chamber.

2. The gas scrubber system as recited in claim 1, wherein the burner comprises an auxiliary rod heater disposed at a center of the burner for diffusing the waste gas radially outwards while applying heat to the waste gas.

3. The gas scrubber system as recited in claim 2, wherein the auxiliary rod heater comprises an elongated center rod disposed concentrically with the burner and a plurality of baffle discs disposed at the center rod with intervals along a longitudinal direction of the center rod.

4. The gas scrubber system as recited in claim 1, wherein the hot filtering unit comprises a plurality of cylidrical ceramic filters extending vertically downwards in parallel with the burner in the combustion chamber of the combustor housing.

5. The gas scrubber system as recited in claim 4, further comprising a filter cleaner for spraying air through the ceramic filters, for forcedly detaching alien material adhered to the ceramic filters.

6. A gas scrubber system comprising:
a waste gas combustor for oxidizing waste gas by heat and for filtering particulates in the oxidized waste gas while the gas is hot;
a cooler unit disposed downstream of the waste gas combustor for cooling down the oxidized waste gas discharged from the waste gas combustor; and
a cold filtering unit disposed downstream of the cooler unit for filtering particulates present in the cold waste gas discharged from the cooler unit,
wherein the waste gas combustor comprises:
a combustor housing having a waste gas introduction port, a combustion chamber and a waste gas discharge port;
a hollow cylindrical burner having a combustion channel interconnecting the waste gas introduction port and the combustion chamber with each other, the burner extending downwards at a center of the combustor housing and adapted to apply heat to the waste gas passing through the combustion channel;
a hot filtering unit disposed between the combustion chamber and the waste gas discharge port of the combustor housing for filtering particulates present in the burned waste gas; and
a dust-collecting unit disposed beneath the combustion chamber of the combustor housing for collecting the particulates falling from the combustion chamber.

7. The gas scrubber system as recited in claim 6, wherein the burner comprises an auxiliary rod heater disposed at a center of the burner for diffusing the waste gas radially outwards while applying heat to the waste gas.

8. The gas scrubber system as recited in claim 7, wherein the auxiliary rod heater comprises an elongated center rod disposed concentrically with the burner and a plurality of baffle discs disposed at the center rod with intervals along a longitudinal direction of the center rod.
